(19) United States
(12) Patent Application Publication
(10) Pub. No.: US 2024/0306873 A1
(43) Pub. Date: Sep. 19, 2024

(54) Cleaning System

(71) Applicant: Anker Innovations Technology Co., Ltd., Changsha (CN)

(72) Inventors: Hongtao Zhang, Shenzhen (CN); Haijun Tan, Shenzhen (CN)

(21) Appl. No.: 18/612,375

(22) Filed: Mar. 21, 2024

Related U.S. Application Data
(63) Continuation of application No. PCT/CN2022/121124, filed on Sep. 23, 2022.

(30) Foreign Application Priority Data
Sep. 24, 2021 (CN) 202111122016.6

(51) Int. Cl. A47L 9/28; A47L 9/00; A47L 9/14; H04B 10/114

(52) U.S. Cl. CPC A47L 9/2894; A47L 9/0063; A47L 9/14; A47L 9/149; A47L 9/2873; A47L 2201/022; A47L 2201/024; H04B 10/114

(57) ABSTRACT

The present disclosure relates to a cleaning system and a method for controlling a cleaning machine. The cleaning system includes a cleaning machine and a base station docking with the cleaning machine to form a physical communication link. The cleaning machine is configured to send work instructions to the base station through the physical communication link after determining that one or more preset conditions are met; and the base station is configured to execute the work instructions.

### CROSS-REFERENCE OF RELATED APPLICATIONS

The present application is a continuation of PCT/CN2022/121124, filed on Sep. 23, 2022, which claims priority to CN 202111122016.6, filed on Sep. 24, 2021, and CN 202280006319.8, filed on Sep. 23, 2022, each of which is incorporated by reference by its entirety.

### FIELD

The present disclosure generally relates to the technical field of a cleaning robot, in particular to a cleaning system.

### BACKGROUND

A base station equipped on a cleaning robot is typically used for charging the cleaning robot, automatically cleaning a dust box waste, automatically replenishing water, automatically cleaning a mop, and displaying cleaning state information of the cleaning robot through a display module. Interaction operation between the cleaning robot and the base station is established on the basis of the need for data communication between the cleaning robot and the base station.

Currently, in the related technology, the commonly used method for data communication between the cleaning robot and the base station is wireless transmission, i.e., a wireless transceiver module such as 433 Mhz of Sub 1G, Bluetooth, or WiFi is installed on the cleaning robot and the base station respectively, thereby achieving “point-to-point” full-duplex data transmission.

### SUMMARY

According to an aspect of embodiments of the present disclosure, the disclosure provides a cleaning system including: a cleaning machine and a base station docking with the cleaning machine to form a physical communication link, wherein the cleaning machine is configured to send work instructions to the base station through the physical communication link when preset conditions are met; the base station is configured to execute the work instructions.

In some embodiments, the cleaning machine includes a dust box configured to collect garbage, and the dust box has a dust outlet; the base station includes a fan, a dust collection port and a dust collection space, in which the dust collection port communicates with the dust outlet and communicates with the dust collection space, and the fan communicates with the dust collection space and sucks the garbage in the dust box into the dust collection space; the cleaning machine is configured to send dust collection instructions to the base station through the physical communication link when preset conditions are met; and the base station is configured to turn on the fan based on the dust collection instructions.

In some embodiments, the cleaning machine is configured to determine whether one or more preset conditions are met as follows: determining a current remaining volume of the dust box and at least one of values in a period between a current time and a time of last dust collection, the at least one of values comprising accumulated cleaning times, and an accumulated cleaning duration; and determining that one or more preset conditions are met when at least one of the following three conditions is met: the accumulated cleaning times are greater than or equal to a threshold of times, the accumulated cleaning duration is greater than or equal to a duration threshold, and the current remaining volume is less than or equal to a volume threshold.

In some embodiments, the cleaning machine implements a process to send dust collection instructions to the base station. The method includes controlling a charging chip of the cleaning machine to be alternately enabled and disabled for a first preset number of times, wherein the charging chip outputs at a high level when it is enabled, and wherein the charging chip outputs at a low level when it is disabled; and after determining that the first preset number of times is greater than a predetermined number of times, causing the base station to turn on the fan.

In some embodiments, after the base station turns on the fan for a predetermined period of time, the fan is turned off to end dust collection.

In some embodiments, the base station is configured to charge the cleaning machine after the fan is turned off.

In some embodiments, before controlling the charging chip of the cleaning machine to be alternately enabled and disabled for the first preset number of times, the charging chip is controlled to be enabled or disabled at least once.

In some embodiments, after determining that the cleaning machine does not meet the one or more preset conditions, the clean machine controls the charging chip of the cleaning machine to be alternately enabled and disabled for a second preset number of times, wherein the charging chip outputs at a high level when it is enabled, and wherein the charging chip outputs at a low level when it is disabled; after determining that the second preset number of times is less than or equal to the predetermined number of times, the charging chip is continuously enabled, and the base station charges the cleaning machine.

In some embodiments, the cleaning machine is provided with a charging contact, the base station is provided with a power supply contact, and the charging contact is configured to be electrically connected to the power supply contact to form the physical communication link.

In some embodiments, the cleaning machine implements a charging process including: controlling the charging chip to be continuously enabled to continuously output at a high level to the base station, so that the base station charges the cleaning machine; after determining that the cleaning machine is charged for a predetermined period of time or a power level of the cleaning machine reaches a predetermined power level, controlling the charging chip to be continuously disabled to terminate a charging state.

In some embodiments, the cleaning machine is further configured to: after receiving a target level signal sent by the base station through the physical communication link, analyze the target level signal to obtain state information of the base station, and synchronize the state information to a target application associated with the cleaning machine and the base station. Alternatively, the cleaning machine is further configured to: receive an infrared signal sent by the base station through the infrared communication link, analyze the infrared signal to obtain state information of the base station, and synchronize the state information to the target application to display the state information through the target application.

In some embodiments, the cleaning machine further includes a first controller configured to transmit a first level waveform carrying working data of the cleaning machine to the base station through the physical communication link after detecting a circuit current between the cleaning machine and the base station; and/or resolve a second level waveform transmitted by the base station through the physical communication link to obtain working data of the base station after the second level waveform is received; and the base station further includes a second controller configured to resolve the first level waveform to obtain working data of the cleaning machine after the first level waveform is received; and/or transmit the second level waveform carrying the working data of the base station to the cleaning machine through the physical communication link after detecting a circuit current.

In some embodiments, the cleaning machine further includes a charging management unit connected with the first controller, the charging management unit is configured to close the charging circuit to form a physical communication link after determining that the charging contact of the cleaning machine is in electrical contact with the power supply contact of the base station, and modulate a first information code characterizing the working data of the cleaning machine into the first level waveform after receiving the first information modulation instruction sent by the first controller.

In some embodiments, the base station further includes a power supply management unit connected to the second controller, the power supply management unit is configured to close the charging circuit to form a physical communication link after determining that the charging contact of the cleaning machine is in electrical contact with the power supply contact of the base station, and modulate a second information code characterizing the working data of the base station into the second level waveform after receiving the second information modulation instruction sent by the second controller.

In some embodiments, the first controller is further configured to: transmit a first information transmission instruction to the charging management unit after determining that the first information code is modulated into the first level waveform and the cleaning machine is in a stationary state; the charging management unit is further configured to: transmit the first level waveform through the physical communication link to the base station based on enabling and disabling operations after receiving the first information transmission instruction.

In some embodiments, the second controller is further configured to: transmit a second information transmission instruction to the power supply management unit after determining that the second information code is modulated into the second level waveform and the cleaning machine is in a stationary state; the power supply management unit is further configured to: transmit the second level waveform through the physical communication link to the cleaning machine based on enabling and disabling operations after receiving the second information transmission instruction.

In some embodiments, the cleaning machine further includes: a first amplifying unit configured to amplify the second level waveform and transmit the amplified result to the first controller; the base station further includes: a second amplifying unit configured to amplify the first level waveform and transmit the amplified result to the second controller.

In some embodiments, the number of the charging contacts of the cleaning machine is at least one, and the number of the power supply contacts of the base station is the same as the number of the charging contacts; when there are a plurality of the charging contacts, different numbers are pre-assigned to the different charging contacts, the number of the power supply contact corresponds to the number of the charging contact, and the charging contact and the power supply contact corresponding to the numbers are connected when data is transmitted between the cleaning machine and the base station.

In some embodiments, the present disclosure provides control logic of the cleaning machine to the base station through the physical communication link, so that there is no need to install a wireless communication module on the base station. Through the physical communication link, the cleaning machine can control function of the base station, which reduces costs and ensures instruction transmission.

### BRIEF DESCRIPTION OF THE DRAWINGS

Accompanying drawings herein are incorporated in the description and constitute a part of the description, illustrate embodiments according to the disclosure, and explain the principle of the disclosure together with the description.

In order to illustrate technical solutions more clearly in embodiments of the disclosure, drawings that need to be used in description of the embodiments are briefly introduced below, and it will be apparent to those of ordinary skill in the art that other drawings can be obtained based on these drawings without inventive work.

FIG. 1 is a schematic diagram of a cleaning system according to an embodiment of the present disclosure;

FIG. 2 is a schematic diagram of another cleaning system according to an embodiment of the present disclosure;

FIG. 3 is an example dust collection instruction according to an embodiment of the present disclosure; and

FIG. 4 is an example non-dust collection instruction according to an embodiment of the present disclosure.

### DETAILED DESCRIPTION

In order to make objectives, technical solutions, and advantages of the disclosure clearer, the technical solutions in the embodiments of the disclosure will be clearly and fully described below in combination with the accompanying drawings in the embodiments of the disclosure. Obviously, the embodiments to be described are part of embodiments but not all embodiments of the disclosure. Based on the embodiments in the disclosure, all other embodiments obtained by those of ordinary skill in the art without inventive work shall fall within the scope of the disclosure.

In the following description, suffixes such as “module”, “component” or “unit” used to represent elements are only used to facilitate description of the present disclosure and have no specific meaning in themselves. Therefore, “module” and “component” can be used interchangeably.

In the related technology, the commonly used method for data communication between the cleaning robot and the base station is wireless transmission, i.e., a wireless transceiver module such as 433 Mhz of Sub 1G, Bluetooth, or WiFi is installed on the cleaning robot and the base station respectively, thereby achieving “point-to-point” full-duplex data transmission.

According to an aspect of the embodiments of the present disclosure, a cleaning system is provided. As shown in FIG. 1, the system includes: a cleaning machine 100, a base station 200 docking with the cleaning machine 100, and a physical communication link 300 formed by docking the cleaning machine 100 with the base station 200.

In the embodiment of the present disclosure, the cleaning machine may be a sweeping machine, a mopping machine, an integrated sweeping and mopping machine, and the like. The base station is a station that provides the cleaning machine with functions such as charging, water replenishment, garbage collection, and connection standby. The cleaning machine may dock with the base station through infrared signals. For example, an infrared transmitting device is installed on the base station to emit an infrared beam outward, and the cleaning machine is provided with an infrared receiving device to find an alignment position based on the received infrared signals, and then enter the alignment position to complete docking with the base station. In addition, the base station may dock with the cleaning machine through a laser. For example, a laser transmitting device is installed on the base station to emit a laser beam outward, and a laser receiving device is installed on the cleaning machine to find an alignment position based on the received laser signals. The cleaning machine and the base station each may be provided with an electrical contact or a signal contact for docking to form the above physical communication link. For example, the cleaning machine is provided with a charging contact, and the base station is provided with a power supply contact. When the docking is completed, the charging contact touches and is electrically connected with the power supply contact to form a charging circuit, and thereby the base station can charge the cleaning machine. Since the charging contact and the power supply contact are electrically connected and electrical signals can be transmitted in the charging circuit, the charging circuit can also serve as the physical communication link.

The cleaning machine 100 is configured to send work instructions to the base station 200 through the physical communication link 300 when preset conditions are met.

In the embodiment of the disclosure, the cleaning machine docks with the base station to accept functional services provided by the base station. That is, before or when the cleaning machine docks with the base station, whether there are functional requirements is first determined, such as whether it requires to collect dust, recycle sewage, replenish clear water, and dry a mop. Therefore, the preset conditions may include but are not limited to corresponding dust collection conditions, sewage recycling conditions, clear water replenishing conditions, mop drying conditions, and the like. If there are the above requirements and the corresponding conditions are met, the cleaning machine may send work instructions to the base station through the physical communication link.

The base station 200 is configured to execute work instructions.

In the embodiment of the present disclosure, the above work instructions include instructions for controlling the base station to perform functions thereof, such as dust collection instructions, sewage recycling instructions, clear water replenishing instructions, mop drying instructions, and the like. It can be understood that with expansion of functions of the base station, the above work instructions are expanded accordingly.

In the embodiment of the present disclosure, the base station is equipped with at least one of a dust collection device, a sewage recycling device, a clear water replenishing device, and a drying device accordingly. The base station controls the corresponding device actions according to the received work instructions to provide the required functions for the cleaning machine.

Taking the dust collection function as an example, a structure and control logic of the cleaning machine and the base station are mainly described below.

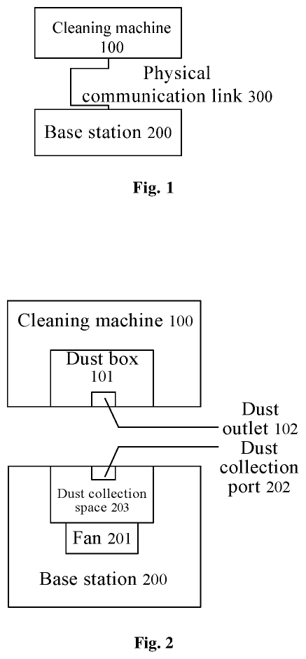

As shown in FIG. 2, in some embodiments, the cleaning machine 100 includes a dust box 101 configured to collect garbage, and the dust box has a dust outlet 102; the base station 200 includes a fan 201, a dust collection port 202 and a dust collection space 203, in which the dust collection port 202 is configured to communicate with the dust outlet 102 and communicate with the dust collection space 203, and the fan 201 is connected with the dust collection space 203 and is configured to suck the garbage in the dust box 101 into the dust collection space 203; it can be understood that a dust bag or a cyclone separator can be used in the dust collection space 203 to collect garbage.

In some embodiments, the dust outlet may be docked with the dust collection port by an interference fit, and a rubber strip may be provided in a contact area between the dust outlet and the dust collection port, so as to seal a docking port when the dust outlet communicates with the dust collection port, prevent air or garbage from leaking due to a gap in the docking port, so that the fan can better suck the garbage in the dust box while generating the same suction force, which not only improves dust collection efficiency, but also prevents garbage from leaking out.

In some embodiments, the base station is provided with a robot arm configured to control the robot arm to extract the dust box from the cleaning machine body and dump the garbage when the base station executes the dust collection instructions.

The cleaning machine 100 is configured to send the dust collection instructions to the base station through the physical communication link after determining that one or more preset conditions are met; the base station 200 is configured to turn on the fan 201 based on the dust collection instructions, and the fan 201 starts working to generate negative pressure, so that the garbage in the box 101 can be sucked into the dust collection space 203. For the dust collection function, the preset conditions here include the dust collection conditions. It is not difficult to understand that the one or more preset conditions match the function of the cleaning machine. When the base station is required to recycle sewage in the cleaning machine, the preset conditions include the sewage recycling conditions. Other functions are the same and are not repeated here.

In some embodiments, in order to ensure maximum dust collection efficiency, the fan operates directly at maximum power, or in order to meet silence requirements, energy saving requirements and the like, the fan operates at lower power, at which time the base station can extend fan operation time to ensure a dust collection effect.

In some embodiments, the cleaning machine is configured to determine whether the preset conditions are met as follows:
Step 1: determining a current remaining volume of the dust box and at least one of values in a period between a current time and a time of last dust collection, and the at least one of values include accumulated cleaning times and an accumulated cleaning duration. It should be noted that conditions for determining whether dust collection is required may include but not be limited to the accumulated cleaning times, the accumulated cleaning duration of the cleaning machine, the current remaining volume of the dust box, and other conditions that those skilled in the art can readily think of and can be used as conditions for determining whether dust collection is required. For example, the cleaning machine may determine whether there is special garbage that cannot be recycled directly by the base station such as broken glass in the dust box. Directly recycling the broken glass by the base station may cause damage to the dust outlet, dust collection port, fan and dust collection space. Therefore, if there is such special garbage, the cleaning machine does not start dust collection, but synchronizes information on the special garbage in the dust box to an application associated with the cleaning machine to prompt a user to manually dispose the special garbage.
Step 2: determining that the preset conditions are met when at least one of the following three conditions is met: the accumulated cleaning times are greater than or equal to a threshold of times, the accumulated cleaning duration is greater than or equal to a duration threshold, and the current remaining volume is less than or equal to a volume threshold.

In the embodiment of the present disclosure, the accumulated cleaning times, the accumulated cleaning duration of the cleaning machine, and the current remaining volume of the dust box can all be used as conditions for determining whether to collect dust. Specifically, meeting any one of the three conditions can be determined as meeting the dust collection conditions, and the cleaning machine performs dust collection accordingly; or meeting two or three of the conditions at the same time can be determined as meeting the dust collection conditions, and the cleaning machine performs dust collection accordingly. For example, the accumulated cleaning times reaching 3 and the accumulated cleaning duration reaching 15 minutes are determined to meet the dust collection conditions. Otherwise, dust collection is not started. The above thresholds of times, duration and volume can be set according to actual needs. For example, the threshold of times may be 1, 2, 3 or above 3, the duration threshold may be 5 min, 15 min, 20 min, or the like, and the volume threshold may be ½, ⅓ or the like of a volume of the dust box.

In some embodiments, a process in which the cleaning machine sends dust collection instructions to the base station includes: controlling a charging chip of the cleaning machine to be alternately enabled and disabled for a first preset number of times, wherein the charging chip outputs at a high level when it is enabled, and wherein the charging chip outputs at a low level when it is disabled. When the first preset number of times is greater than a predetermined number of times, the base station turns on the fan.

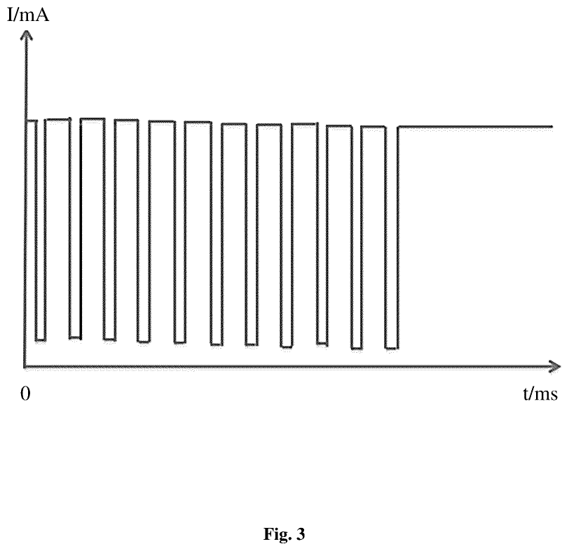

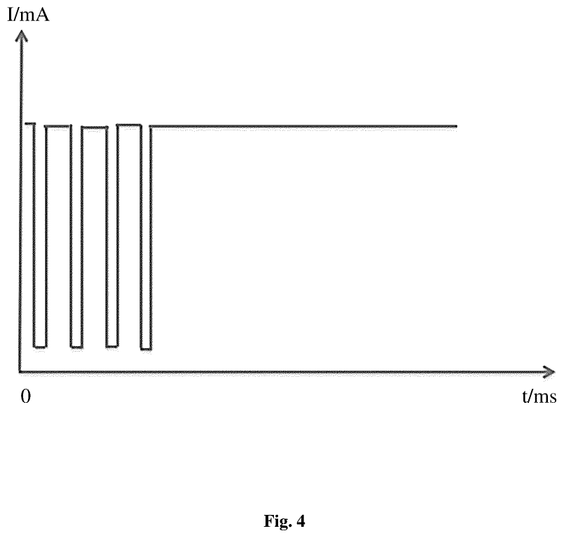

In the embodiment of the present disclosure, as shown in FIG. 3, the cleaning machine determines that the dust collection conditions are met, that is, controls the charging chip to be alternately enabled and disabled for the first preset number of times. The charging chip outputs at a high level in an enabled state, and the charging chip outputs at a low level in a disabled state, and the charging chip is alternately enabled and disabled to generate cyclic high and low levels. When the number of high and low level cycles received by the base station (i.e., the first preset number) is greater than the set number of times, the base station turns on the fan to collect dust. A current value greater than 600 mA may be set as a logic high level, and a current value less than 30 mA may be set as a logic low level. It can be understood that setting of the high and low levels can be adjusted according to actual needs. For example, greater than 400 mA or greater than 800 mA may be set as a logic high level, and less than 100 mA and less than 20 mA may be set as a logic low level. The above first preset number of times and predetermined number of times can be set according to actual needs. For example, if the predetermined number of times is 3, as long as the first preset number of times is greater than 3, that is, the base station receives more than 3 high and low level cycles, the base station receives the dust collection instructions and needs to turn on the fan to collect dust from the cleaning machine.

In the embodiment of the present disclosure, an interval in which the charging chip is alternately enabled and disabled may be controlled within a preset interval to shorten instruction transmission time. In addition, when the charging chip is alternately enabled and disabled, duration of each enablement may be equal to, greater than, or less than duration of each disablement, which is not uniquely limited here.

In some embodiments, after the base station turns on the fan for a predetermined period of time, the fan is turned off to end dust collection.

In the embodiment of the present disclosure, a predetermined period of time may be preset for execution time of each function of the base station. When a time period for the base station to execute a certain function reaches the preset execution time of the function, the base station stops execution. Taking the dust collection function as an example, when the base station turns on the fan to collect dust for a predetermined period of time, the base station automatically turns off the fan to end dust collection. In this embodiment, the predetermined period of time may be 10 s, 15 s, 20 s, and the like.

In some embodiments, the cleaning machine may determine a state of the dust box before the base station ends dust collection. If there is still a lot of garbage left in the dust box, the cleaning machine may control the charging chip to be alternately enabled and disabled for the first preset number of times to send dust collection instructions to the base station again, so that the base station extend the dust collection time. A solution for the cleaning machine to determine the state of the dust box is to detect a dust box weight at the current moment and subtract a preset dust box weight from the dust box weight at the current moment in some embodiments. The preset dust box weight is a dust box weight with all the garbage emptied. When the difference is greater than a weight threshold, it is determined that there is still a lot of garbage in the dust box and dust collection needs to continue. Alternatively, the current remaining volume of the dust box may be detected and compared with an available volume threshold. If the remaining volume is less than the available volume threshold, it is determined that there is still a lot of garbage in the dust box and dust collection needs to continue. The above weight threshold may be set according to actual needs, such as 50 grams, 100 grams, and 200 grams. The above available volume threshold may also be set according to actual needs, such as one-fifth, one-quarter, and one-third of the total volume.

In the embodiment of the present disclosure, as shown in FIG. 3, during operation of the fan, the charging chip continues outputting at a high level to ensure smooth progress of the dust collection operation.

In some embodiments, the base station is configured to charge the cleaning machine after the fan is turned off.

In the embodiment of the present disclosure, after the base station turns off the fan, if no other work instruction is received, the base station starts to charge the cleaning machine in response to the continuously received high level. A charging process includes: the cleaning machine controls the charging chip to be continuously enabled to continuously output at a high level to the base station, so that the base station charges the cleaning machine; after determining that the cleaning machine is charged for a predetermined period of time or the power level of the cleaning machine reaches a predetermined power level, the charging chip is controlled to be continuously disabled to terminate the charging state. After that, the base station may enter a standby state or sleep state to maintain low power consumption.

In some embodiments, before controlling the charging chip of the cleaning machine to be alternately enabled and disabled for the first preset number of times, the charging chip is controlled to be enabled or disabled at least once.

In the embodiment of the present disclosure, the base station does not start to determine the number of cycles of high and low levels to identify the work instructions as soon as the base station receives the high and low level signals from the cleaning machine. Since there is a false level signal caused by unstable contact, the base station may calculate the number of cycles of high and low levels after receiving stable level signals to ensure accuracy of instruction reception. Therefore, before the cleaning machine controls the charging chip to be alternately enabled and disabled for the first preset number of times, to the cleaning machine controls the charging chip to be enabled or disabled at least once. Correspondingly, the first preset number of times may be set to be larger than the predetermined number of times. For example, the predetermined number of times is 3, and the first preset number of times may be set as 10, so that the base station can accurately identify a number of high and low level cycles greater than 3 and turns on the fan to collect dust.

In some embodiments, when the cleaning machine does not meet the preset conditions, the charging chip of the cleaning machine is controlled to be alternately enabled and disabled for a second preset number of times; alternatively, when the second preset number of times is less than or equal to the set number of times, the charging chip is continuously enabled and the base station charges the cleaning machine.

In the embodiment of the present disclosure, when the cleaning machine determines that the preset conditions are not met, that is, when the cleaning machine has no specific functional requirements, the base station is directly notified to charge the cleaning machine. Taking the cleaning machine which determines that dust collection is not required as an example, if the dust collection conditions are not met, the cleaning machine sends a non-dust collection instruction to the base station, as shown in FIG. 4. That is, the cleaning machine controls the charging chip to be alternately enabled and disabled for the second preset number of times. If the second preset number is less than or equal to the predetermined number of times, the base station is notified that dust collection is not required. After that, the cleaning machine controls the charging chip to be continuously enabled to output a continuous high level to the base station. When the base station receives the non-dust collection instruction, that is, when there is no need to turn on the fan and no other instructions, the base station charges the cleaning machine in response to the continuous high level. That is, when the second preset number of times is less than or equal to the predetermined number of times, the charging chip continues being enabled and continuously outputs at a high level to the base station, so that the base station charges the cleaning machine. In this embodiment, the predetermined number of times may be 3, and the corresponding second preset number of times may be 3, 2, or 1, which is not uniquely limited here.

Similarly, before controlling the charging chip of the cleaning machine to be alternately enabled and disabled for the second preset number of times, the charging chip is controlled to be enabled or disabled at least once to ensure accuracy with which the base station receives instructions.

In some embodiments, the above physical communication link may be implemented based on the contacts. In some embodiments, the cleaning machine is provided with a charging contact, the base station is provided with a power supply contact, and the charging contact is configured to be electrically connected to the power supply contact to form the physical communication link. That is, in this embodiment, through electrical contact between the charging contact and the power supply contact, the cleaning machine not only charges the base station, but also transmits instructions to the base station, such as dust collection instructions, sewage recycling instructions, clear water replenishing instructions, mop drying instructions, and the like.

In the embodiment of the present disclosure, instructions are sent and data is transmitted between the cleaning machine and the base station through the physical communication link. There is no need to install a separate communication module on the base station, which saves costs, but the cleaning machine touches the base station by a contact. When the base station charges the cleaning machine, the physical communication link is constructed through the charging contact of the cleaning machine and the power supply contact of the base station, so that the cleaning machine can send work instructions to the base station. It can be understood that in other embodiments, other methods can be used to establish a physical communication link between the cleaning machine and the base station. For example, the cleaning machine and the base station realize electrical contact between the charging contact and the power supply contact to realize the connection between the base station and the base station. The charging of the cleaning machine realizes the transmission of instructions from the cleaning machine to the base station through other contact. Based on this method, the cleaning machine can be charged and send instructions at the same time.

In some embodiments, the base station may send base station state data to the cleaning machine through the physical communication link formed by the electrical contact between the charging contact and the power supply contact, or send the base station state data to the cleaning machine through a physical communication link formed by electrical contact of other contacts. In this embodiment, the base station state data includes but is not limited to working state information such as a base station dust bag dust accumulation capacity, a clear water tank water volume, a sewage tank water volume, and a fan state.

In this embodiment, when the base station sends a signal to the cleaning machine through the physical communication link, the cleaning machine receives a target level signal sent by the base station through the physical communication link, analyzes the target level signal to obtains state information of the base station, and synchronizes the state information to a target application associated with the cleaning machine and base station to display state information through the target application. A user can obtain working states of the cleaning machine and the base station in real time through the target application. When an abnormality occurs in the cleaning machine or the base station, the user can handle the abnormality in time.

In some embodiments, there is at least one pair of the charging contacts and the power supply contacts, and each pair can implement the physical communication link. In a case where there are multiple physical communication links, the cleaning machine and the base station can perform data communication simultaneously.

In some embodiments, the cleaning system further includes an infrared communication link. When the cleaning machine receives an infrared signal sent by the base station through the infrared communication link, the infrared signal is analyzed to obtain the state information of the base station, and synchronizes the state information to a target application to display state information through the target application.

It is worth noting that the cleaning machine in this embodiment returns to the base station and is charged through the infrared communication link. The cleaning machine locates a location of the base station based on the infrared signal sent by the base station and walks toward the location of the base station, and the charging contact accurately docks with the power supply contact based on the infrared signal.

The present disclosure provides control logic of the cleaning machine to the base station through the physical communication link, so that there is no need to install a wireless communication module on the base station. Through the physical communication link, the cleaning machine can control function of the base station, which reduces costs and ensures instruction transmission.

In some embodiments, the present disclosure further provides a cleaning system. In this embodiment, the cleaning machine further includes a first controller configured to transmit a first level waveform carrying working data of the cleaning machine to the base station through the physical communication link after detecting a circuit current between the cleaning machine and the base station; and/or resolve a second level waveform transmitted by the base station through the physical communication link to obtain working data of the base station after the second level waveform is received. A base station includes a second controller configured to resolve the first level waveform to obtain working data of the cleaning machine after the first level waveform is received; and/or transmit the second level waveform carrying the working data of the base station to the cleaning machine through the physical communication link after a circuit current is detected.

In this embodiment, the charging contact on the cleaning machine is in electrical contact with the power supply contact on the base station to form a charging circuit, and the base station can charge the cleaning machine based on the charging circuit. Since the charging contact and the power supply contact are electrically connected and an electrical signal can be transmitted in the charging circuit, the charging circuit can serve as the physical communication link. When the first controller detects the circuit current between the cleaning machine and the base station, it is determined that the cleaning machine docks with the base station. At this time, the working data of the cleaning machine can be transmitted to the base station through the physical communication link. The working data of the cleaning machine includes work instructions sent by the cleaning machine to the base station, that is, the first level waveform carries the work instructions. Similarly, when the second controller detects the circuit current, it is determined that the base station docks with the cleaning machine. At this time, the working data of the base station can be sent to the cleaning machine through the physical communication link, that is, working state information such as the base station dust bag dust capacity, the clear water tank water volume, the sewage tank water volume, and the fan state can be sent to the cleaning machine through the second level waveform.

It is readily understandable that the first level waveform at least includes a level waveform when the cleaning machine sends the dust collection instructions to the base station as shown in FIG. 3, a level waveform when the cleaning machine sends the non-dust collection instructions to the base station as shown in FIG. 4, a continuous high-level waveform when the base station charges the cleaning machine, and a continuous low-level waveform when the cleaning machine does not need to be charged or has been charged.

In some embodiments, the cleaning machine further includes a charging management unit connected to the first controller, the charging management unit is configured to close a charging circuit to form a physical communication link when the charging contact of the cleaning machine is in electrical contact with the power supply contact of the base station, and modulate a first information code characterizing the working data of the cleaning machine into the first level waveform after the first information modulation instruction sent by the first controller is received.

In the embodiment of the present disclosure, the charging management unit includes the above charging chip. The first information code includes work instructions that the first controller needs to send to the base station after determining whether the cleaning machine meets the above preset conditions. The first information modulation instruction includes a control instruction that the first controller instructs the charging management unit to send the first information code.

In some embodiments, the base station further includes a power supply management unit connected to the second controller, the power supply management unit is configured to close the charging circuit to form a physical communication link when the charging contact of the cleaning machine is in electrical contact with the power supply contact of the base station, and modulate a second information code characterizing the working data of the base station into the second level waveform after the second information modulation instruction sent by the second controller is received.

In the embodiment of the present disclosure, the power supply management unit includes a power supply on the base station, the second information code includes state data of the base station, and the second information modulation instruction includes a control instruction that the second controller instructs the power supply management unit to send the second information code.

In some embodiments, the first controller is further configured to: transmit a first information transmission instruction to the charging management unit after determining that the first information code is modulated into the first level waveform and the cleaning machine is in a stationary state; and the charging management unit is further configured to: transmit the first level waveform through the physical communication link to the base station based on enabling and disabling operations after the first information transmission instruction is received.

In some embodiments, the second controller is further configured to: transmit a second information transmission instruction to the power supply management unit after determining that the second information code is modulated into the second level waveform and the cleaning machine is in a stationary state; the power supply management unit is further configured to: transmit the second level waveform through the physical communication link to the cleaning machine based on enabling and disabling operations after the second information transmission instruction is received.

In some embodiments, the cleaning machine further includes: a first amplifying unit configured to amplify the second level waveform and transmit the amplified result to the first controller; the base station further includes: a second amplifying unit configured to amplify the first level waveform and transmit the amplified result to the second controller.

In some embodiments, a number of the charging contacts of the cleaning machine is at least one, and a number of the power supply contacts of the base station is the same as the number of the charging contacts; when there are a plurality of the charging contacts, different numbers are pre-assigned to the different charging contacts, the number of the power supply contact corresponds to the number of the charging contact, and the charging contact and the power supply contact corresponding to the numbers are connected when data is transmitted between the cleaning machine and the base station.

In the embodiment of the present disclosure, a physical communication link is formed when the charging contact and the power supply contact with corresponding numbers are connected. Multiple physical communication links can enable data communication of the cleaning machine and the base station simultaneously.

The present disclosure provides control logic of the cleaning machine to the base station through the physical communication link, so that there is no need to install a wireless communication module on the base station. Through the physical communication link, the cleaning machine can control function of the base station, which reduces costs and ensures instruction transmission.

It can be understood that the embodiments described herein may be implemented in hardware, software, firmware, middleware, microcode, or a combination thereof. For the hardware implementation, a processing unit can be implemented in one or more application specific integrated circuits (ASIC), digital signal processing (DSP), digital signal processing devices (DSP Devices, DSPD), programmable Logic devices (PLD), field-programmable gate arrays (FPGA), general-purpose processors, controllers, microcontrollers, microprocessors, other electronic units that perform the functions described in the disclosure, or a combination thereof.

For software implementation, the technique described herein may be implemented by means of units that perform the functions described herein. Software codes may be stored in a memory and executed by a processor. The memory may be implemented in the processor or outside the processor.

Those of ordinary skill in the art can realize that units and algorithm steps of each example described in combination with the embodiments disclosed herein can be implemented by electronic hardware or combination of computer software and electronic hardware. Whether these functions are implemented by hardware or software depends on specific application and design constraints of the technical solution. Those of professional skill can use different methods to realize the described functions for each specific application, but the realization should not be considered beyond the scope of the present disclosure.

Those skilled in the art may clearly understand that, for convenience and brevity of description, the specific operation process of the above system, device and unit may refer to the corresponding process in the above method embodiments, and details are not described herein again.

In the embodiments provided in the present disclosure, it should be understood that the disclosed device and method can be implemented in other ways. For example, the above-described embodiments of the device are only schematic, for example, division of the modules is only logical function division, and there may be other ways of division in actual implementation, for example, a plurality of modules or components may be combined or integrated into another system, or some features may be ignored or not executed. In another point, mutual coupling or direct coupling or communication connection shown or discussed may be indirect coupling or communication connection through some interfaces, devices or units, and may be in electrical, mechanical or other forms.

The units illustrated as separate components may or may not be physically separate, the components shown as units may or may not be physical units, that is, may be located in one place or distributed to a plurality of network elements. The purpose of the embodiment may be implemented by selecting some or all of the units therein according to actual needs.

In addition, the functional units in the embodiments of the present disclosure may be integrated into one processing unit, or the functional units may be present separately physically, or two or more functional units may be integrated into one unit.

If the functions are realized in the form of software function units and sold or used as an independent product, the functions may be stored in a computer-readable storage medium. Based on this understanding, the technical solutions of the embodiments of the present disclosure essentially or the part that contributes to the prior art or a part of the technical solutions may be embodied in the form of a software product which is stored in a storage medium and includes several instructions to cause a computer device (which may be a mobile phone, a personal computer, a server, a network device, or the like) to execute all or part of steps of the method described in the embodiments of the disclosure. The above storage medium includes: various media capable of storing program codes such as a U disk, a mobile hard disk, a ROM, a RAM, a magnetic disk or an optical disk. It should be noted that relationship terms such as “first” and “second” are used solely for distinguishing one entity or operation from another entity or operation herein without necessarily requiring or implying any actual relationship or order among the entities or operations. Furthermore, the terms “include”, “comprise”, or any other variants thereof are intended to encompass non-exclusive inclusion, so that a process, method, article, or device comprising a series of elements not only comprises those elements but further comprises other elements not expressly listed or elements inherent to such a process, method, article or device. Without more limitations, an element defined by a phrase “comprise a . . . ” does not exclude the presence of additional identical elements in the process, method, article, or device that comprises the element.

The foregoing is only the detailed description of the disclosure to enable a person skilled in the art to understand or implement the disclosure. Various modifications to these embodiments will be apparent to a person skilled in the art, and general principles defined herein can be implemented in other embodiments without departing from the spirit or scope of the disclosure. Thus, the present disclosure is not limited to the embodiments illustrated herein, but conforms to the widest scope consistent with the principle and novel characteristics disclosed herein.

What is claimed is:

1. A cleaning system comprising:
a cleaning machine and a base station docking with the cleaning machine to form a physical communication link,
wherein the cleaning machine is configured to send, via the physical communication link, to the base station and after determining that one or more preset conditions are met, work instructions; and
wherein the base station is configured to:
receive, from the cleaning machine and via the physical communication link, the working instructions; and
execute the work instructions.

2. The cleaning system of claim 1, wherein:
the cleaning machine comprises a dust box having a dust outlet, wherein the dust box collects garbage;
the base station comprises a fan, a dust collection port and a dust collection space, wherein the dust collection port communicates with the dust outlet and communicates with the dust collection space, and wherein the fan communicates with the dust collection space and sucks the garbage in the dust box into the dust collection space;
the cleaning machine is further configured to send, via the physical communication link and after determining that the one or more preset conditions are met, dust collection instructions to the base station; and
the base station is configured to turn on the fan based on the dust collection instructions.

3. The cleaning system of claim 2, wherein the cleaning machine is configured to determine whether the one or more preset conditions are met by:
determining a current remaining volume of the dust box and at least one of values in a period between a current time and a time of last dust collection, the at least one of values comprising accumulated cleaning times and an accumulated cleaning duration; and
determining that the one or more preset conditions are met, wherein the one or more preset conditions comprise that:
the accumulated cleaning times are greater than or equal to a threshold number of times,
the accumulated cleaning duration is greater than or equal to a duration threshold, and
the current remaining volume is less than or equal to a volume threshold.

4. The cleaning system of claim 2, wherein the cleaning machine is further configured to send the dust collection instructions to the base station by:
controlling a charging chip of the cleaning machine to be alternately enabled and disabled for a first preset number of times, wherein the charging chip outputs at a high level when it is enabled, and wherein the charging chip outputs at a low level when it is disabled; and
after determining that the first preset number of times is greater than a predetermined number of times, causing the base station to turn on the fan.

5. The cleaning system of claim 2, wherein the base station is further configured to:
after the base station turns on the fan for a predetermined period of time, turns off the fan to terminate dust collection.

6. The cleaning system of claim 5, wherein the base station is further configured to charge the cleaning machine after the fan is turned off.

7. The cleaning system of claim 4, wherein the cleaning machine is further configured to:
prior to controlling the charging chip of the cleaning machine to be alternately enabled and disabled for the first preset number of times, enable or disable the charging chip at least once.

8. The cleaning system of claim 4, wherein the cleaning machine is further configured to:
after determining that the cleaning machine does not meet the preset conditions, control the charging chip of the cleaning machine to be alternately enabled and disabled for a second preset number of times; and
after determining that the second preset number of times is less than or equal to the predetermined number of times, cause:
the charging chip to be continuously enabled; and
the base station to charge the cleaning machine.

9. The cleaning system of claim 8, wherein the cleaning machine is further configured to:
control the charging chip to be continuously enabled to continuously output at a high level to the base station, wherein the base station charges the cleaning machine; and
after determining that the cleaning machine is charged for a predetermined period of time or a power level of the cleaning machine reaches a predetermined power level, control the charging chip to be continuously disabled to terminate a charging state.

10. The cleaning system of claim 1, wherein:
the cleaning machine is provided with a charging contact,
the base station is provided with a power supply contact, and
the charging contact is electrically connected to the power supply contact to form the physical communication link.

11. The cleaning system of claim 1, wherein the cleaning machine is further configured to:
after receiving, from the based station and via the physical communication link, a target level signal:
analyze the target level signal to obtain state information of the base station; and
synchronize the state information to a target application associated with the cleaning machine and the base station; or
after receiving, from the base station and via an infrared communication link, an infrared signal:
analyze the infrared signal to obtain the state information of the base station; and
synchronize the state information to the target application to display the state information through the target application.

12. The cleaning system of claim 10, wherein the cleaning machine further comprises a first controller configured to:
transmit, to the base station, via the physical communication link and after detecting a circuit current between the cleaning machine and the base station, a first level waveform carrying working data of the cleaning machine; and
resolve a second level waveform transmitted by the base station via the physical communication link to obtain working data of the base station after the second level waveform is received; and
wherein the base station further comprises a second controller configured to:
resolve the first level waveform to obtain working data of the cleaning machine after the first level waveform is received; and
transmit, to the cleaning machine, via the physical communication link and after detecting the circuit current, the second level waveform carrying the working data of the base station.

13. The cleaning system of claim 12, wherein the cleaning machine further comprises a charging management unit connected with the first controller, the charging management unit is configured to:
close a charging circuit to form the physical communication link after determining that the charging contact of the cleaning machine is in electrical contact with the power supply contact of the base station; and
modulate a first information code characterizing the working data of the cleaning machine into the first level waveform after determining that a first information modulation instruction sent by the first controller is received.

14. The cleaning system of claim 12, wherein the base station further comprises a power supply management unit connected to the second controller, the power supply management unit is configured to:
close a charging circuit to form the physical communication link after determining that the charging contact of the cleaning machine is in electrical contact with the power supply contact of the base station; and
modulate a second information code characterizing the working data of the base station into the second level waveform after determining that a second information modulation instruction sent by the second controller is received.

15. The cleaning system of claim 13, wherein the first controller is further configured to:
transmit a first information transmission instruction to the charging management unit after determining that the first information code is modulated into the first level waveform and the cleaning machine is in a stationary state; and
wherein the charging management unit is further configured to:
transmit, via the physical communication link to the base station, and based on enabling and disabling operations, the first level waveform after determining that the first information transmission instruction is received.

16. The cleaning system of claim 14, wherein the second controller is further configured to:
transmit a second information transmission instruction to the power supply management unit after determining that the second information code is modulated into the second level waveform and the cleaning machine is in a stationary state; and
wherein the power supply management unit is further configured to:
transmit, via the physical communication link to the cleaning machine and based on enabling and disabling operations, the second level waveform after determining that the second information transmission instruction is received.

17. The cleaning system of claim 12, wherein the cleaning machine further comprises a first amplifying unit configured to:
amplify the second level waveform; and
transmit the amplified result to the first controller; and
wherein the base station further comprises a second amplifying unit configured to:
amplify the first level waveform; and
transmit the amplified first level waveform to the second controller.

18. The cleaning system of claim 13, wherein:
the cleaning machine comprises at least one charging contact, and
a number of the power supply contacts of the base station is the same as a number of charging contacts; and
after determining that there are a plurality of the charging contacts:
different numbers are pre-assigned to different charging contacts,
the number of the power supply contact corresponds to the number of the charging contact, and
the charging contact and the power supply contact corresponding to the numbers are connected when data is transmitted between the cleaning machine and the base station.

19. A method for controlling a cleaning machine comprising a dust box that collects garbage, the method comprising:
determining a current remaining volume of the dust box and at least one of values in a period between a current time and a time of last dust collection, the at least one of values comprising:
accumulated cleaning times, and
an accumulated cleaning duration;
determining that one or more preset conditions are met, wherein the one or more preset conditions comprise that:
the accumulated cleaning times are greater than or equal to a threshold number of times,
the accumulated cleaning duration is greater than or equal to a duration threshold, and
the current remaining volume is less than or equal to a volume threshold; and
after determining that the one or more preset conditions are met:
sending, to a base station docking with the cleaning machine to form a physical communication link and via the physical communication link, work instructions; and
causing the base station to execute the work instructions.

20. The method of claim 19, further comprising:
controlling a charging chip of the cleaning machine to be alternately enabled and disabled for a first preset number of times, wherein the charging chip outputs at a high level when it is enabled, and wherein the charging chip outputs at a low level when it is disabled; and
after determining that the first preset number of times is greater than a predetermined number of times, causing the base station to turn on a fan.
